(19) United States
(12) Patent Application Publication
(10) Pub. No.: US 2025/0269687 A1
(43) Pub. Date: Aug. 28, 2025

(54) WHEEL RIM

(71) Applicant: FRATELLI INDUSTRIES LTD., TAICHUNG CITY (TW)

(72) Inventor: Gavin Michael VOS, TAICHUNG CITY (TW)

(21) Appl. No.: 18/673,500

(22) Filed: May 24, 2024

(30) Foreign Application Priority Data
Feb. 23, 2024 (TW) 113201891

(51) Int. Cl. B60B 21/02

(52) U.S. Cl. CPC B60B 21/026

(57) ABSTRACT

A wheel rim includes an inner rim wall, two side rim walls extending upwardly and outwardly from two lateral sides of the inner rim wall, two flanges integrally extending from upper ends of the side rim walls respectively, two support ribs integrally and downwardly extending from the flanges to an inner side of the inner rim wall respectively, and an outer rim wall annularly arranged corresponding to the inner rim wall and having two lateral sides integrally connected with the support ribs, respectively. The wheel rim includes two hollow structures formed by the side rim walls, the flanges, and the support ribs and having a lower end lower than a juncture between the outer rim wall and one of the support ribs, thereby providing a stable structure to result in minimized deformation of the wheel rim when the wheel rim receives external forces.

### BACKGROUND OF THE INVENTION

### 1. Field of the Invention

The present invention relates to a wheel rim and more particular, to a wheel rim having a minimized deformation when receiving external forces.

### 2. Description of the Related Art

FIG. 7 shows a conventional tubeless bicycle wheel 110, which is composed of a wheel rim 120 and an outer tire 130. The wheel rim 120 has an outer rim wall 121, which has two opposing side rim walls 122. Each side rim wall 122 has a hook portion 123 at its top end. The outer tire 130 has two opposing tire beads 131. In assembly, the tire beads 131 of the outer tire 130 are mounted to the side rim walls 122 of the wheel rim 120, and air is filled between the wheel rim 120 and the outer tire 130, so that the tire beads 131 of the outer tire 130 can be tightly abutted against the inner surfaces of the side rim walls 122 of the wheel rim 120 and the hook portions 123.

However, as shown in FIG. 8, when the tubeless bicycle tire 110 is subjected to external forces (e.g., during turning), the wheel rim 120 and the outer tire 130 are compressed and deformed. If the deformation of the wheel rim 120 is too large, it may cause one of the tire beads 131 of the outer tire 130 to disengage from the side rim wall 122 that the tire bead is originally abutted to, such that a gap G may exist between the side rim wall 122 and the tire bead 131. This may cause a problem that the gas filled between the wheel rim 120 and the outer tire 130 may escape through the gap G, resulting in insufficient tire pressure of the outer tire 130. Therefore, providing a wheel rim with minimal deformation when subjected to external forces is an issue that the industry needs to address.

### SUMMARY OF THE INVENTION

The present invention has been accomplished in view of the above-noted circumstances. It is an objective of the present invention to provide a wheel rim, which may have a minimized deformation when receiving external forces.

To attain the above objective, the present application provides a wheel rim comprises an inner rim wall, two side rim walls, two flanges, two support ribs, and an outer rim wall. The inner rim wall has an inner side. The side rim walls extend upwardly and outwardly from two lateral sides of the inner rim wall, respectively. Each of the two flanges integrally extends from a top end of one of the side rim walls. Each of the two support ribs integrally and downwardly extends from one of the flanges to the inner side of the inner rim wall. The outer rim wall is annularly arranged corresponding to the inner rim wall and has two lateral sides integrally connected with the two support ribs, respectively. The wheel rim further comprises two hollow structures, and each of the hollow structures is formed by one of the side rim walls, one of the flanges, and one of the support ribs in a way that each of the hollow structures has a lower end lower than a juncture between the outer rim wall and one of the support ribs.

With the above technical features, the hollow structures provided by the wheel rim of the present invention provides a more stable structure to the wheel rim, resulting in minimized deformation of the wheel rim when the wheel rim receives external forces, thereby preventing an outer tire mounted on the wheel rim of the present invention from escape.

Preferably, each of the side rim walls includes a lower connection section extending from the inner rim wall, a vertical section extending from the lower connection section, and an upper connection section extending from the vertical section and being connected with one of the flanges. Each of the support ribs extends integrally downward from a bottom edge of one of the flanges to a junction between the inner side of the inner rim wall and the lower connection section of one of the side rim walls, such that each of the hollow structures may have an upper end and the lower end.

Preferably, each of the support ribs extends downward vertically or inclinedly, such that each of the hollow structures has a tapered shape narrowing gradually from the upper end to the lower end thereof.

Preferably, each of the support ribs extends downward vertically and is parallel to the vertical section of each of the side rim walls, such that the upper end and the lower end of each of the hollow structures have substantially a same width.

Preferably, each of the support ribs extends downward inclinedly. The lower connection section extends inclinedly from the inner rim wall, and the upper connection section extends inclinedly from the vertical section in a way that the upper end and the lower end of each of the hollow structures are tapered.

Preferably, the wheel rim of the present invention may further include two reinforcement ribs each having two lateral sides connected with the inner side of the inner rim wall and an inner side of the outer rim wall.

Preferably, each of the flanges has a hook portion. Accordingly, the two tire beads of the tire are less likely to detach from the hook portions.

Preferably, an upper portion of each of the support ribs is provided with a plurality of first ribs. Accordingly, the two tire beads of the tire are less likely to detach from the support ribs.

Preferably, each of the lateral sides of the outer rim wall is provided with an abutment section connected with one of the support ribs. Each of the abutment sections has a protruding stop portion or a plurality of second ribs. Accordingly, the two tire beads of the tire are less likely to detach from the abutment sections.

Preferably, the lower end of each of the hollow structures may be lower than each of the abutment sections of the outer rim wall.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a partially cross-sectional perspective view of a wheel rim according to a first embodiment of the present invention;

FIG. 2 is a front cross-sectional view of the wheel rim of the first embodiment of the present invention, showing an outer tire is mounted to the wheel rim;

FIG. 3 is a front cross-sectional view of a wheel rim according to a second embodiment of the present invention;

FIG. 4 is a front cross-sectional view of a wheel rim according to a third embodiment of the present invention;

FIG. 5 is a front cross-sectional view of a wheel rim according to a fourth embodiment of the present invention;

FIG. 6 is a front cross-sectional view of a wheel rim according to a fifth embodiment of the present invention;

FIG. 7 is a front cross-sectional view showing that an outer tire is mounted to a conventional wheel rim; and

FIG. 8 a schematic view showing that the wheel rim shown in FIG. 7 is in a state under external force compression.

### DETAILED DESCRIPTION OF THE INVENTION

The technical content and features of the present invention will be described in detail in conjunction with the drawings through one or more embodiments described below. The directional descriptive terms such as “up, down, inner, outer, top, and bottom” mentioned in the specification are merely exemplary descriptive terms based on normal usage directions and are not intended to limit the scope of the claims.

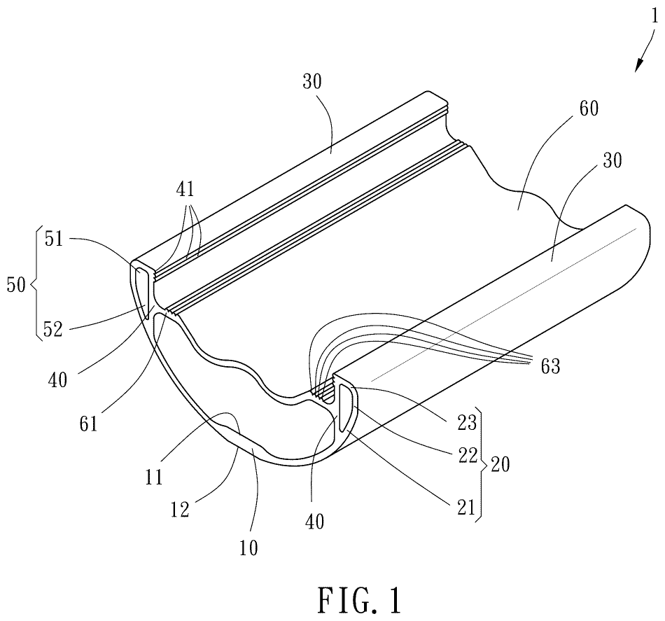

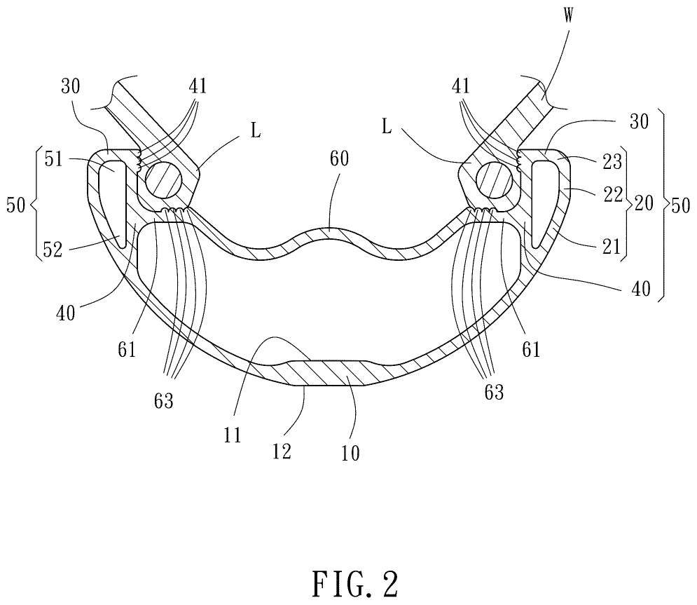

Referring to FIGS. 1 and 2, a wheel rim 1 provided by a first embodiment of the present invention is composed of an inner rim wall 10, two side rim walls 20, two flanges 30, two support ribs 40, and an outer rim wall 60.

The inner rim wall 10 has an inner side 11 and an outer side 12 opposite to the inner side 11.

The two side rim walls 20 integrally extend upward and outward from two lateral sides of the inner rim wall 10, respectively. More specifically, each side rim wall has a lower connection section 21 extending arcuately from the inner rim wall 10, a vertical section 22 extending vertically from the lower connection section 21, and an upper connection section 23 extending arcuately from the vertical section 22.

The flanges 30 integrally extend horizontally from the upper connection sections 23 of the side rim walls 20, respectively.

The upper portions of the support ribs 40 are provided with a plurality of first ribs 41, and each of the support ribs 40 extends vertically downward from a bottom edge of one of the flanges 30 to a junction between the inner side 11 of the inner rim wall 10 and the lower connection section 21 of one of the side rim walls 20, such that the side rim wall 20, the flange 30, and the support rib 40 collectively form a hollow structure 50 having an upper end 51 and a lower end 52. In this embodiment, the hollow structure 50 has a tapered shape narrowing gradually from the upper end 51 to the lower end 52 thereof.

The outer rim wall 60 has two lateral sides each provided with an abutment section 61. The abutment section 61 is integrally connected to one of the support ribs 40, such that the lower end 52 of each hollow structure 50 is lower than each abutment section 61 of the outer rim wall 60. Furthermore, each abutment section 61 has a plurality of second ribs 63.

As shown in FIG. 2, in assembly, the two tire beads L of an outer tire W are mounted between the abutment sections 61 of the outer rim wall 60 and the support ribs 40 of the wheel rim 1. Gas is then filled between the wheel rim 1 and the outer tire W, such that the tire beads L of the outer tire W can be tightly abutted to the abutment sections 61 of the outer rim wall 60 and the support ribs 40 of the wheel rim 1. At this time, the first ribs 41 of the support ribs 40 can prevent the tire beads L of the outer tire W from escape from the support ribs 40, while the second ribs 63 of the outer rim wall 60 can prevent the tire beads L of the outer tire W from escape from the abutment sections 61.

To determine the deformation amount of the wheel rim 1 of the first embodiment of the present invention under a single external force impact and the difference from conventional wheel rims, a single impact test is conducted as a basis for evaluation. The test results are shown in the following Table 1.

TABLE 1

| Tested Samples | Deformation |
|---|---|
| Example 1 | 0.94 mm |
| Comparative example 1 | 1.14 mm |
| Comparative example 2 | 2.18 mm |

As shown in Table 1, single impact tests were conducted with three test samples (Example 1 and Comparative Examples 1 and 2 in Table 1), which are wheel rims having approximately the same length and width. Specifically, Example 1 is a wheel rim made in accordance with the first embodiment of the present invention. comparative Example 1 is a conventional wheel rim without a hollow structure 50 of the present invention. Comparative Example 2 corresponds to another conventional wheel rim having a structure similar to the wheel rim 1 of the first embodiment of the present invention, except that the lower end 52 of the hollow structure 50 and the abutment section 61 of the outer rim wall 60 are at the same horizontal height.

In the single impact test, an impact head of a weight 33 kg was used, and each test sample is fixed on a fixture directly under the impact head. During the impact tests, the impact head was raised to a height of 500 millimeters above the test sample and then released to fall down and thus impact each test sample. After the impact, the deformation of each test sample was measured, and the ability of each test sample to withstand external impact forces was determined based on the deformation.

Referring to Table 1 again, the deformation of Example 1 was 0.94 millimeters, which is the lowest among all test samples; the deformation of Comparative Example 1 was 1.14 millimeters, which is the median value among all test samples; and the deformation of Comparative Example 2 was 2.18 millimeters, which is the highest among all test samples. Thus, based on the aforementioned data, it can be concluded that in the single impact tests, Example 1, i.e., the wheel rim 1 of the first embodiment of the present invention, exhibited better resistance to single impact forces compared to conventional wheel rims.

In another aspect, to evaluate the difference in deformation between the wheel rim 1 of the first embodiment of the present invention and conventional wheel rims under continuous impact forces, continuous impact tests were conducted. The test results are shown in the following Table 2.

TABLE 2

| | Deformations under different impact heights | | | | |
|---|---|---|---|---|---|
| Tested | Height | Height | Height | Height | Height |
| Samples | 100 mm | 200 mm | 300 mm | 400 mm | 500 mm |
| Example 1 | 0.18 mm | 0.52 mm | 0.71 mm | 1.90 mm | 2.72 mm |
| Comparative | 0.20 mm | 0.35 mm | 1.12 mm | 2.39 mm | 3.08 mm |
| example 1 | | | | | |
| Comparative | 0.47 mm | 0.97 mm | 2.90 mm | 3.84 mm | 4.11 mm |
| example 1 | | | | | |

As shown in Table 2, continuous impact tests were conducted with three test samples, which are identical to the samples in the aforementioned Table 1, and thus will not be repeatedly illustrated here.

In the continuous impact tests, an impact head of a weight 33 kg was used, and each test sample is fixed to a fixture directly under the impact head. During the impact tests, the impact head was raised to a height of 100 millimeters above the test sample and then released to fall down and thus impact each test sample. After the impact, the deformation of each test sample was measured. Subsequently, the height of the impact head was increased by 100 millimeters (i.e., the impact height was increased to 200 millimeters), and then the impact head is released to thus impact the same position on each test sample again. This process was repeated, increasing the height of the impact head incrementally until the impact height reached 500 millimeters. The ability of each test sample to withstand external impact forces was determined based on the final deformation of each test sample (i.e., the deformation of each test sample when the impact height was 500 millimeters).

Referring to Table 2 again, the final deformation of Example 1 was 2.72 millimeters, which is the lowest among the test samples. The final deformation of Comparative Example 1 was 3.08 millimeters, which is the median value among the test samples. The deformation of Comparative Example 2 was 4.11 millimeters, which is the highest among the test samples. From these data, it can be concluded that in the continuous impact tests, Example 1, i.e., the wheel rim 1 of the first embodiment of the present invention, exhibited better ability to withstand continuous external impact forces compared to conventional wheel rims.

Furthermore, to evaluate the difference in deformation between the wheel rim 1 of the first embodiment of the present invention and conventional wheel rims under loads, static load tests were conducted. The test results are shown in the following Table 3.

TABLE 3

| Tested | Deformation under different loads | | | |
|---|---|---|---|---|
| Samples | Load 33 kg | Load 43 kg | Load 53 kg | Load 63 kg |
| Example 1 | 0.05 mm | 0.07 mm | 0.09 mm | 0.11 mm |
| Comparative | 0.08 mm | 0.11 mm | 0.13 mm | 0.15 mm |
| example 1 | | | | |
| Comparative | 0.07 mm | 0.10 mm | 0.12 mm | 0.14 mm |
| example 2 | | | | |

As shown in Table 3, static load tests were conducted with three test samples, which are identical to the samples in the aforementioned Table 1, and thus will not be repeatedly illustrated here.

In the static load tests, an impact head of a weight 33 kg was used, and each test sample is fixed on to fixture directly under the impact head. During the tests, the impact head was pressed against each test sample, causing deformation of each test sample under the weight of the impact head. After the test, the deformation of each test sample was measured separately. Then, an additional weight of 10 kilograms was added to the impact head, making the load 43 kilograms, and then the impact head was pressed against the same position of each test sample again. Subsequently, 10 kilograms of weights were added successively to conduct the aforementioned test until the load reached 63 kilograms. The ability of each test sample to withstand the load was determined by the final deformation amount of each test sample (the deformation amount of each test sample when the load was 63 kilograms).

Referring to Table 3, the final deformation amount of Example 1 was 0.11 millimeters, which is the lowest among the test samples. The final deformation amount of Comparative Example 2 was 0.14 millimeters, which is the median value among the test samples. The deformation amount of Comparative Example 1 was 0.15 millimeters, which is the highest among the test samples. Therefore, it can be seen from the above data that in the static test, Example 1, i.e., the wheel rim 1 of the first embodiment of the present invention, has a better ability to withstand the load compared to conventional wheel rims.

From the above-mentioned three tests, it can be seen that the deformation amount of the wheel rim 1 of the first embodiment of the present invention is the lowest when subjected to external impact and load. In other words, the hollow structure provided by the wheel rim 1 of the first embodiment of the present invention allows for better overall structural strength, resulting in less deformation when the wheel rim 1 is subjected to external force, and thus making it less likely for the tire beads L of the outer tire W mounted on the wheel rim 1 to detach from the support ribs 40 and the abutment sections 61 of the outer rim wall 60.

The structural features of the wheel rim 1 provided in the first embodiment of the present invention are as described above. However, the present invention is not limited to what is disclosed in this embodiment. That is, the wheel rim 1 can have different structural variations, providing different styles for users to choose from.

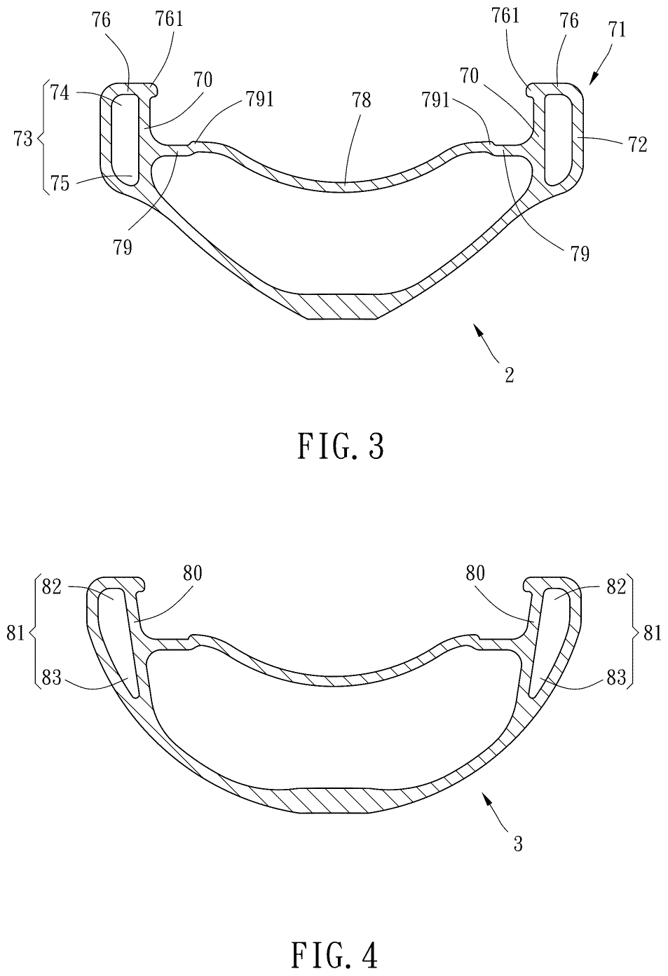

FIG. 3 shows a wheel rim 2 provided by a second embodiment of the present invention, which is generally similar to that of the first embodiment. The difference lies in that each support rib 70 extends vertically downward and is parallel to the vertical section 72 of each side rim wall 71. Additionally, the length of the vertical section 72 of each side rim wall 71 is greater than that of the vertical section 22 of each side rim wall 20 in the previous first embodiment, resulting in that the upper end 74 and the lower end 75 of each hollow structure 73 may have a same or similar width. Furthermore, each flange 76 provided in this embodiment has a hook portion 761, and each abutment section 79 of the outer rim wall 78 has a protruding stop portion 791.

FIG. 4 shows a wheel rim 3 provided in a third embodiment of the present invention, which is generally similar to that of the second embodiment. The difference lies in that each support rib 80 extends downward and inclinedly at an angle, such that the hollow structure 81 may have a tapered shape gradually narrowing from the upper end 82 to the lower end 83 thereof.

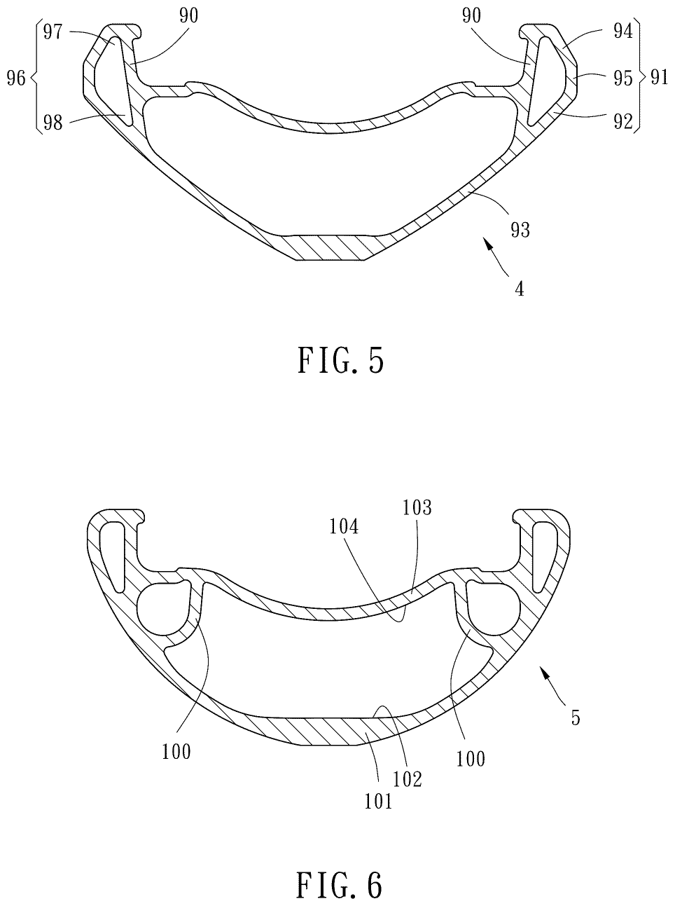

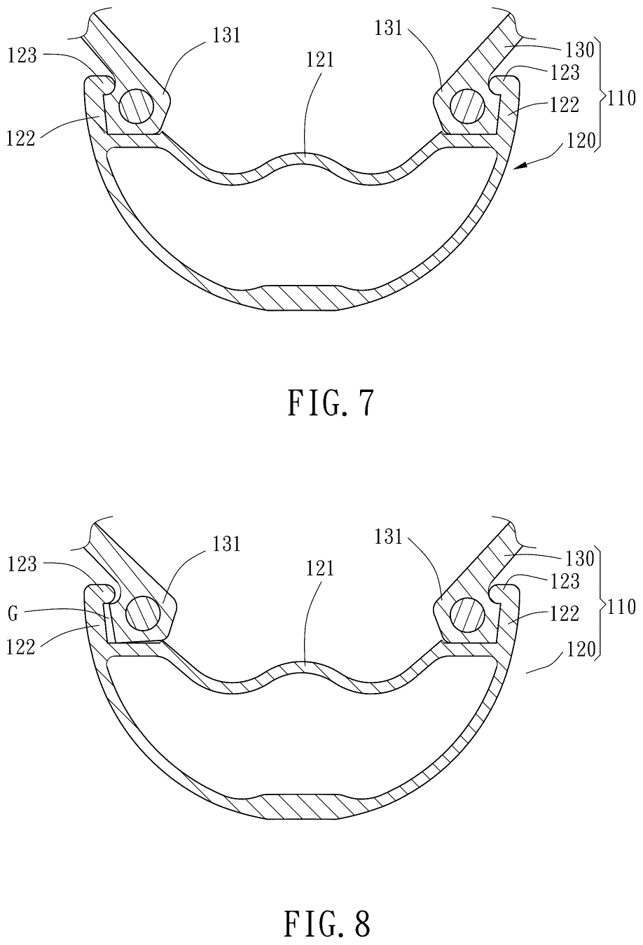

FIG. 5 shows a wheel rim 4 provided in a fourth embodiment of the present invention, which is generally similar to that of the second embodiment. The difference lies in that each support rib 90 extends downward and inclinedly at an angle, and each lower connection section 92 of each side rim wall 91 extends inclinedly from the inner rim wall 93 at an angle, while each upper connection section 94 extends inclinedly from each vertical section 95 at an angle in a way that the extension directions of the upper connection section 94 and the lower connection section 92 are intersected with each other, resulting in that the upper end 97 and the lower end 98 of each of the hollow structures 96 are tapered.

FIG. 6 shows a wheel rim 5 provided in a fifth embodiment of the present invention, which is generally similar to that of the second embodiment. The difference lies in that the wheel rim 5 in this embodiment further includes two reinforcement ribs 100. Each reinforcement rib 100 has two lateral sides connected to the inner side 102 of the inner rim wall 101 and the inner side 104 of the outer rim wall 103, making the structure of the wheel rim 5 more stable. It will be appreciated that the aforementioned two reinforcement ribs 100 may also be applied to the wheel rims 1, 2, 3, and 4 provided in the first, second, third, and fourth embodiments of the present invention to provide various structural features.

The effects of the wheel rims 2, 3, 4, and 5 provided in the second, third, fourth, and fifth embodiments are completely identical to or similar to those of the wheel rim 1 provided in the first embodiment, so they are not repeatedly illustrated here.

At last, it should be mentioned again that the constituent elements disclosed in the above embodiments of the present invention are only taken as examples for illustration, not intended to limit the scope of the present invention. The substitution or variation of other equivalent elements should be included within the scope of the following claims of the present invention.

What is claimed is:

1. A wheel rim, comprising:
an inner rim wall having an inner side;
two side rim walls extending upwardly and outwardly from two lateral sides of the inner rim wall;
two flanges each integrally extending from a top end of one of the side rim walls;
two support ribs each integrally and downwardly extending from one of the flanges to the inner side of the inner rim wall; and
an outer rim wall annularly arranged corresponding to the inner rim wall and having two lateral sides integrally connected with the support ribs, respectively;
wherein the wheel rim further comprises two hollow structures each formed by one of the side rim walls, one of the flanges, and one of the support ribs in a way that each of the hollow structures has a lower end lower than a juncture between the outer rim wall and one of the support ribs.

2. The wheel rim as claimed in claim 1, wherein each of the side rim walls includes a lower connection section extending from the inner rim wall, a vertical section extending from the lower connection section, and an upper connection section extending from the vertical section and being connected with one of the flanges; each of the support ribs extends integrally downward from a bottom edge of one of the flanges to a junction between the inner side of the inner rim wall and the lower connection section of one of the side rim walls, such that each of the hollow structures has an upper end and the lower end.

3. The wheel rim as claimed in claim 2, wherein each of the support ribs extends downward vertically or inclinedly, such that each of the hollow structures has a tapered shape narrowing gradually from the upper end to the lower end thereof.

4. The wheel rim as claimed in claim 2, wherein each of the support ribs extends downward vertically and is parallel to the vertical section of each of the side rim walls, such that the upper end and the lower end of each of the hollow structures have substantially a same width.

5. The wheel rim as claimed in claim 2, wherein each of the support ribs extends downward inclinedly; the lower connection section extends inclinedly from the inner rim wall, and the upper connection section extends inclinedly from the vertical section in a way that the upper end and the lower end of each of the hollow structures are tapered.

6. The wheel rim as claimed in claim 1, further comprising two reinforcement ribs each having two lateral sides connected with the inner side of the inner rim wall and an inner side of the outer rim wall.

7. The wheel rim as claimed in claim 1, wherein each of the flanges has a hook portion.

8. The wheel rim as claimed in claim 1, wherein an upper portion of each of the support ribs is provided with a plurality of first ribs.

9. The wheel rim as claimed in claim 1, wherein each of the lateral sides of the outer rim wall is provided with an abutment section connected with one of the support ribs; each of the abutment sections has a protruding stop portion or a plurality of second ribs.

10. The wheel rim as claimed in claim 9, wherein the lower end of each of the hollow structures is lower than each of the abutment sections of the outer rim wall.
